(19) United States
(12) Patent Application Publication
(10) Pub. No.: US 2003/0149744 A1
(43) Pub. Date: Aug. 7, 2003

(54) Secure identification system combining forensic/biometric population database and issuance of relationship-specific identifiers toward enhanced privacy

(76) Inventors: Pierre Bierre, Pleasanton, CA (US); Lynn Lybeck, Moss Beach, CA (US)

Correspondence Address: Pierre Bierre, VeracID Systems, 980 Riesling Dr., Pleasanton, CA, 94566-7220, US

(21) Appl. No.: 10/301,266

(22) Filed: Nov. 20, 2002

Related U.S. Application Data
(60) Provisional application No. 60/331,645, filed on Nov. 20, 2001.

(51) Int. Cl. G06F 15/16

(52) U.S. Cl. 709/217

(57) ABSTRACT

An ID infrastructure design to combat identity theft and identity fraud while enhancing individual privacy is disclosed. The schema revolves around two persons who want to do business non-anonymously (i.e. with strong bad faith traceability), and a centralized identification service IS that fields queries from one of them (the requestor R) who requests the identity of the other U. The identification service IS owns a highly secure forensic/biometric population database wherein R and U are represented individually. Upon positive match to their respective personas in the database, R receives an identifier for U, issued for R's exclusive use. Unlike a universal identifier (e.g. SSN), the identifier issued is relationship-specific, i.e. it allows the person being identified U to be known by a different identifier in each business relationship he establishes. The identification service IS remembers the identifiers it issues and to whom, and will always return the same identifier when queried by R for the identity of U, thus affording R the ability to impose lifetime ID stability on U (or any person he does business with). The identification service IS is able to provide location tipoffs to law enforcement arising from ID queries involving wanted persons, imposing inescapable traceability on bad faith actors. The two major advantages of this ID infrastructure design are 1) an integrated solution to fraud-resistant ID, enhanced individual privacy, bad faith traceability, checks on organizational identity frauds, and 2) a centralized architecture which simplifies maintenance of security over invaluable forensic/biometric data assets, and provides an efficient way to deliver secure identification services throughout society.

### CROSS-REFERENCE TO RELATED APPLICATIONS

This application is made pursuant to U.S. Provisional Patent Application 60/331,645 filed Nov. 20, 2001 by the same inventors.

### STATEMENT REGARDING FEDERALLY SPONSORED RESEARCH OR DEVELOPMENT

None of the inventive work being applied for herein was sponsored by the U.S. Government.

### FIELD OF THE INVENTION

The field of the invention is infrastructure for secure identification of persons in the general population, including birth recording, issuance of identifiers, establishment of business relationships, maintenance of privacy protections, and traceability of bad faith actors. The field also includes identification/privacy of organizations. The content of the invention should be understandable to a person skilled in the art of systems infrastructure and software applications.

### BACKGROUND OF THE INVENTION

Identification of individuals is a necessary underpinning to an open society offering freedom of association. Birth certificates, drivers licenses, Social Security numbers (or other national identifiers), and passports all evolved to satisfy administrative needs to identify an individual as a unique entity among a population. Equally important, ID instruments and systems strive to establish continuity of same identity over an individual's lifetime, a necessary underpinning to the rule of law and dependable commerce. Otherwise, the unscrupulous will present false identity to obtain goods and services without paying, dodge creditors, and evade the criminal justice system.

Identity fraud has become a prevalent problem, with adverse effects throughout society. The opportunities for fraud have increased due to several trends. Vastly increased mobility of persons has created a situation where interaction with strangers is the business norm. High resolution printers and software have given document forgers the tools to doctor image-based IDs. Computerized database systems have made it possible for organizations to establish relationships with millions of customers, but without knowing in any deep sense who these people are. The internet is built on top of communication protocols concerned only with ID of computers, not the people using them. Administratively, no branch of government has been given clear responsibility for developing ID infrastructure, measuring its performance, and making improvements.

Though the ability of humans to identify someone familiar seems dependable and intuitive, as of yet there is no complete scientific explanation of this phenomenon to apply directly to design of automated ID systems. However, there are some fundamental characteristics and purposes of human identification that inform the architect of such systems:

initial encounter—the appearance of an individual never before encountered triggers representation invoking a brand new identifier

recognition—in response to reappearance of an individual previously encountered, representation invokes the same identifier previously associated with this person

identifier—a symbolic token employed to uniquely represent a specific individual, drawn from a set of tokens capable of representing a population

trustability decision—a decision as to whether it is prudent to establish a relationship with an individual, made at the time of initial encounter, or later, upon evaluating available information

bad faith traceability—in the case of bad faith performance or illegality, a way to locate/notify the perpetrator and leverage consequences as needed to restore accountability, up to and including civil remedies/physical arrest.

The issuing of national identifiers, such as Social Security numbers in the U.S., while unintentionally satisfying the demand for identifiers to represent people in data systems, has fostered an erosion of privacy, and created opportunities for ID fraud. The privacy shield is lowered because information given over voluntarily in a private business relationship is stored under a universal identifier, making it potentially accessible by anyone else having access to a person's identifier. ID theft is as simple as obtaining and impostering behind someone else's identifier (along with personal information unlocked through it). Or, an alias (fictitious identity) may be created by fraudulently obtaining new gateway documents, e.g. SSN or birth certificate, then a new drivers license. Either fraud accomplishes the criminal's goal of thwarting bad faith traceability.

As an example of the current adhoc and ineffective approach to identification, most retail store managers require checkout cashiers to write identifying information on personal checks such as drivers license number and birth date. The rationale for doing so is bad faith traceability. These retailers have chosen to accept drivers licenses as a valid form of ID for lack of anything better. The DMV issuing the DL cannot vouch for the authenticity of it bearer, because the DMV accepts non-secure gateway documents, such as birth certificates and SSNs, as the basis for the drivers licensee's identity.

Forensics, such as fingerprinting and DNA, and biometrics arising from a multitude of bodily signals, offer the potential to capture in a data system the type of immutable indicia that would make it possible to impose ID stability over a lifetime. However, these strong techniques, if introduced into a universal identifier environment, open the possibility of automated tracking of individual behavior, and the assembling of highly detailed dossiers from data mining, all against the wishes of the individual. Even more chilling is the seeming inevitability that one's forensic/biometric signature, if acquired and stored in a proliferation of biometric application databases, will eventually fall into the hands of criminals, and be misused to spoof authenticated transactions. Breach of security over one's stored forensic/biometric signature is calamitous compared to breach of a password, because new DNA and fingerprints cannot be issued to an individual.

Large population forensic and biometric ID systems have so far been limited to captive populations, such as military inductees and felons. If forensic/biometrics are to live up to their potential, and gain public acceptance as a tool for combating ID fraud, they must be integrated into an overall ID/Privacy architecture designed to assure the privacy of an individual's conduct, and personal information given over in private business relationships. And, the ID infrastructure must be designed and operated in a manner that either precludes altogether, or renders worthless, deceptive use of biometric data

As an example of inadequate bad faith traceability, law enforcement is hampered by an inability to quickly locate and apprehend crime suspects. Using forensic crime scene markers such as fingerprints and DNA, investigators often acquire the evidence that could be used to convict the perpetrator if only he could be identified. The current FBI forensic databases (AIFIS for fingerprints, CODIS for DNA) are limited to felons, leaving first-time offenders out of reach. The result is that many serious crimes go unsolved, and perpetrators remain free to continue offending. Identity fraud has become a mainstream tool of underworld types seeking a way to stay one step ahead of the authorities. By obtaining a new drivers license under an alias, a career criminal can completely sanitize his rap sheet and suppress outstanding arrest warrants if pulled over. What is needed is a more ironclad link between crime and perpetrator—a non-repudiation mechanism for bad faith behavior, making it highly probable that bad actors will be quickly located and consequences levied. With effective bad faith traceability as a core feature of ID infrastructure, fewer will be tempted to commit crime in the first place.

In summary, there is an unmet society-wide need to devise a means for securing the identity of individuals, able to withstand determined attempts at ID theft and fraud. A closely related, unsolved problem is the loss of individual privacy resulting from widespread dissemination of Social Security numbers in conjunction with their use as de facto universal identifiers. Another closely related problem is the ineffectiveness of businesses and law enforcement at bad faith traceability, which reflects the ease with which identity can be obscured. Strong means of identification based on forensic and biometric data have the potential to stabilize identification of an individual over a lifetime, but allowing these technologies to proliferate in an unregulated manner could make matters much worse by inadvertently allowing forensic/biometric signatures to fall into the hands of criminals.

The solution to the foregoing related problems appeals for design of a carefully architected ID infrastructure, drawing together the right blend of computer and human elements, realistically estimating the effects of good and ill motives, and able to solve the stated problems without inflicting yet more vexing dilemmas.

### BRIEF SUMMARY OF THE INVENTION

The invention teaches a high-level systems architecture for an ID/Privacy infrastructure. Several key innovations define the invention. First and foremost is its recognition of the need to infuse reliable identification services with strong privacy architecture, so that law-abiding citizens can enjoy security from ID frauds without giving up the ability to conduct their affairs in private. Identification is approached as highly centralized, ultra-secure service, in which an individual's unique forensic (and biometric) persona is stored over the individual's lifetime starting from birth. Provision for secure update to one's biometric signature is provided using a forensic baseline. At key junctures when the individual desires to establish a relationship with an organization requiring secure identification (e.g. obtaining a passport, drivers license, employment), identification is established by sending an identification query to a centralized ID service.

The information comprising the query is the ID of the requesting organization, and a live scan of forensic/biometric data collected from the applicant. If the individual can be positively matched to a known biometric persona, the response returned is a relationship-specific identifier, a unique number usable as a local identifier within the requesting organization for representing the individual over all encounters. Another organization requesting the identity of this same individual will be issued a different lifetime identifier. The effect of this architecture is that the identifiers issued serve the need of each organization to know whom they are dealing with across time, but prevent unauthorized sharing of data about the individual across organizations. Use of relationship-specific identifiers is able to protect the privacy (non-sharability) of personal information indexed under them in databases, and thus such identifiers function as secure identifiers.

Secure identifiers are designed to replace national identifiers, such as Social Security number in the U.S., and other de facto universal identifiers, which inadvertently make it possible to automatically correlate personal information given over privately to unrelated organizations.

Bad faith traceability is established by empowering a single organization issuing secure identifiers to keep a relationship list for each individual, listing the secure identifiers issued and to whom. Under due process safeguards, the relationship list may be consulted as an entry point to crime investigation, and a location tipoff may be generated by trapping incoming identification queries for a wanted person.

The essence of the invention is an ID architecture whereby a centralized identification service keeps a database of biometric/forensic personas, and uses it to support highly automated ID services offered to a wide array of client organizations wishing to identify individuals at he outset of a relationship, or thereafter. The ID service provides the client organization with a secure identifier, for use as a local database index with which to represent the individual over all lifetime transactions. The ID service maintains a list of all relationships and identifiers issued for this individual, in order to provide bad faith traceability. The individual who performs with good faith in relationships enjoys the ability to conduct these relationships in private, by virtue of the issuance of secure identifiers (as opposed to use of a universal identifier).

### BRIEF DESCRIPTION OF THE SEVERAL VIEWS OF THE DRAWING

FIG. 1—Schema Depicting Identification Transaction. Illustrates role of centralized identification service IS in furnishing a secure identifier to a requestor for an unknown person U. Illustrates the use of the secure identifier in R's database environment.

FIG. 2—Issuance of Relationship-Specific Identifiers for Individual U Establishing Two Relationships. Illustrates the privacy architecture of the current invention by comparing two relationships established by the same individual.

FIG. 3—Extent of Information Retained About Individual U in Identification Service Database. Illustrates minimization of centralized storage of data about an individual needed to support ID services. Shows details of a relationship list containing secure identifiers.

FIG. 4—Extent of Information Retained About Organization X in Identification Service Database.

4a illustrates data storage needs for managing an organizational ID, and

4b illustrates a secure identifier issued to a party who is dealing opposite from an organization.

FIG. 5—Traceability of Secure ID Over Individual Lifespan. Illustrates means for imposing forensic birth to death ID stability on individuals, while supporting biometric signature updating to adapt to maturational changes. Illustrates judicious use of secure identification at the establishment of important relationships.

FIG. 6—Details for Processing Identification Query. Flowchart describing the details of processing an identification query.

### DETAILED DESCRIPTION OF THE INVENTION

Identity

The human faculty for recognizing familiar people is remarkably robust. The question of what it means to identify someone is shrugged off as intuitively obvious by the majority of people. However, for specialists in forensic science, the question has stood as a central enigma for more than 100 years, and one, which remains unwieldy, as judged by the emergence of identity fraud as the fastest growing area of crime.

Confronting ID crime by proactively designing secure ID infrastructure requires first applying some rigor to the concept of identity. For purposes of the present invention, identity is conceptualized as having two fundamental aspects:

Identity=

That which differentiates an individual as a unique entity among a population.

That constancy which bridges across the all the interactions with an individual over time.

The second aspect of identity appeals to the notion of relationships. The ability to establish and nurture relationships depends entirely on flawlessly associating temporally-separated interactions with an individual across time. Identity is the bridge, that which remains constant across all interactions that comprise the relationship.

There is a natural symmetry in dyadic (e.g., 2 person) relationships that makes them a good choice upon which to build a foundation. The two people who form a relationship essentially have equal needs for stable identification of the other. The concept of identity can be extended to organizations, so that, for example, the relationship between a government agency and an individual, or between an individual customer and a company, or a company and a company, can all benefit from secure ID infrastructure.

Bad Faith Traceability

Bad faith traceability is the property in a relationship where knowing the identity of a party who has wronged you is sufficient to track them down, communicate grievances, and levy consequences, including leveraging reputation tools. Ironclad bad faith traceability is a strong deterrent, and the surest means of securing good faith behavior in relationships. Most ID frauds are committed with the sole purpose of severing traceability. Much of the personal information organizations insist on collecting from individuals at the start of a relationship is a contingency for bad faith traceability—escalation, consequences, and recovery. Law enforcement is very effective when there is bad faith traceability, for instance obtaining positive ID of a perpetrator from automated matching of fingerprints or DNA in a forensic database. Law enforcement is ineffective when there is not bad faith traceability. In the cavalcade of impersonal, fleeting relationships we have come to accept as part of modern life, the major rationale for being able to identify people is deterrence of bad faith.

IDs for Organizations, Authenticated Agency

When it comes to the relationship between an individual and an organization, symmetry is worth preserving, i.e., there is no less of a need for constancy of identity. As a measure of trustworthiness, organizations are expected to operate on the same level as individuals by establishing an ID, and having all transactional behavior on behalf of the organization be personally-authenticated (where the other party requests it). This provides a symmetric accountability relationship between individuals and organizations. This concept places a check on the ability to mount fraud under cloak of an untraceable organization, or through unauthorized agency (role impostering).

Privacy

Identification systems impact so directly on privacy that, from the standpoint of the present invention, nothing less than an integrated design that achieves both simultaneously will gather the necessary level of public acceptance. Before this can be done, intellectual rigor must be applied to the concept of privacy.

The present invention assumes a traditional, time-tested model of private commerce, where parties in a relationship share information locally on a voluntary basis, as needed to establish trustability and consummate business. The invention defines privacy as follows:

Privacy=The ability to share information voluntarily and locally within a relationship toward a mutually understood purpose, with assurances that the information will not be divulged to parties outside the relationship, nor applied to purposes beyond that for which it was voluntarily given.

Implicit in this definition is a strong aversion to clandestine capture of information.

From the standpoint of the present invention, the prevailing decentralized database architecture of society offers natural privacy benefits, and is worth reinforcing by way of ID infrastructure going into the future. The alternative—proposals to amass personal information in huge, centralized databases through data mining, whether at the hands of government or corporations, poses risks to fundamental liberties out of proportion to any benefits proposed. The invention imparted herein employs technical means, via the issuance of secure identifiers, to make intractable unpermissioned data mining.

Equipped with the foregoing definitions for identity, bad faith traceability, and privacy, the stage is set for technical explication of the invention.

Secure Identification

In the present invention, identification is defined rigorously. The schema revolves around the establishment of a new dyadic relationship between persons U and R, who are unknown to each other, but who desire to do business in an environment of trust. An identification service IS, already established and in possession of uniquely differentiating forensic/biometric signatures for a population of individuals including U and R, plays a key role in providing mutual identification services. Because of exact symmetry of U and R, it is sufficient to explain how U becomes identified to R.

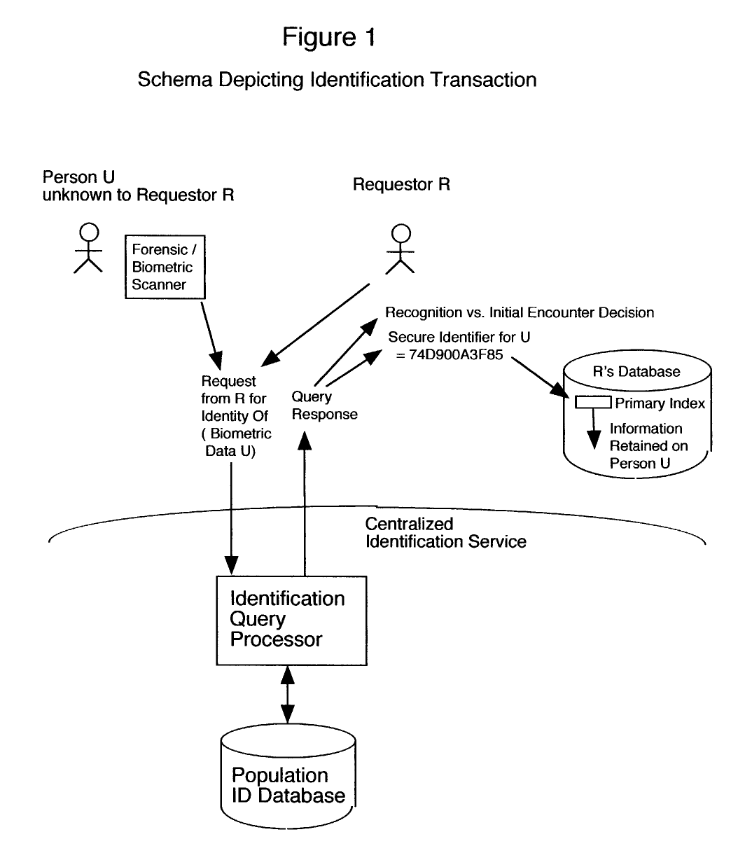

Identification (as shown in FIG. 1) consists of a query sent to the identification service IS by a requestor R, incorporating a forensic/biometric scan of unknown person U, and requesting the identity of this person. After internal processing of the query at the identification service, a response is sent back to R in the form of an identifier for U. The query must contain a fresh vector of forensic/biometric data scanned from U. If the IS is able to positively match the scanned data vector to a persona represented in its forensic/biometric population database, two pieces of information are returned to the requestor R:

Recognition vs. Initial Encounter Decision

Secure Identifier: Identifier for representing U in R's database environment over an indefinite relationship duration

Initial Encounter vs. Recognition

The first datum answers R's crucial need to know if he is dealing with an initial encounter (he has not previously requested the identity of biometric person U), or a recognition (R has previously requested the identity of biometric person U, and been issued an identifier for U).

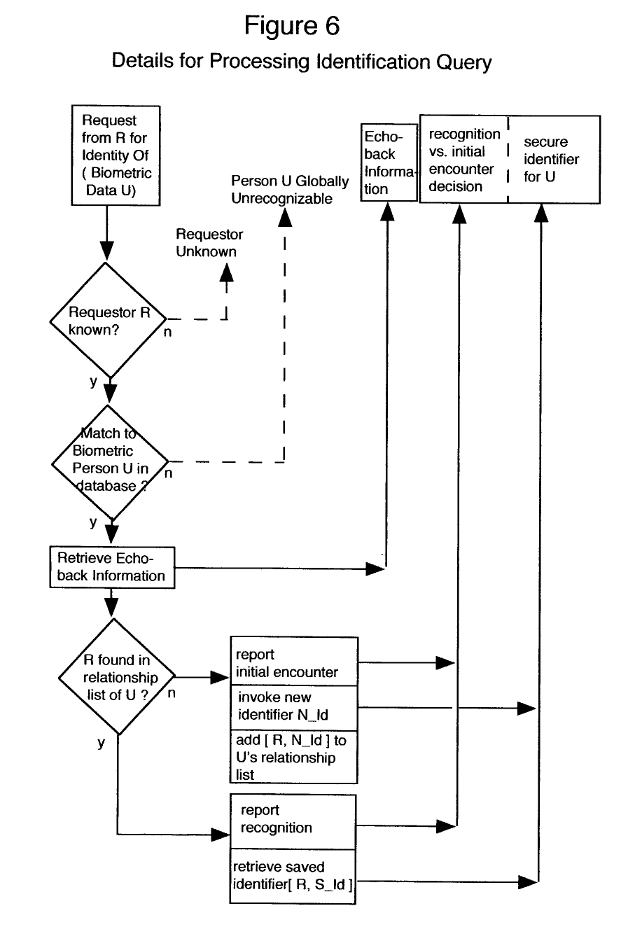

The details of the identification transaction are shown in FIG. 6. In the case of an initial encounter, the IS invokes a brand new identifier, and issues it to the requesting party R as the identity of U. Importantly, the IS stores a record of having issued this identifier to R, so that in the future, if R again requests the identity of U, recognition will be signaled and the same identifier will be returned. The IS supports secure recognition of U by always returning the same identifier for this individual when R requests his identity. This feature counters a broad class of ID frauds, typified by the criminal who obtains a 2nd drivers license under an alias, in order to obtain a clean driving record and dissociation from his criminal history.

The identifier is a large integer (e.g. 64-bit) which is suitable for R to use as a primary database index for storing and accessing all information about person U. FIG. 1 illustrates how R puts the issued identifier to immediate use as a primary database key for all the information he stores locally about person U. This identifier meets the needs of R to impose lifelong ID stability on U, so as to preclude giving out fraudulent alias relationships to U. In the event of bad faith, R can request the Identification Service to help track down U, and within legal due process, locate him by trapping incoming queries matching his biometric signature.

To summarize, from R's point of view, identifying unknown person U consists of querying an authority with a forensic/biometric vector, and receiving back from it an identifier which will 1) always be the same in response to his queries for ID of this individual, 2) never collide with an identifier R is issued for another individual, and 3) be effective in locating U in the event of bad faith.

Minimization of Information Stored by Identification Service

One of the central tenets driving the present invention is that a highly-centralized identification service should limit the extent of information stored in its database to the minimum necessary to provide identification services. The idea is to completely decouple identification of individuals from information retrieval about individuals. The reason for this decoupling is vested in privacy rights—mere identification of an individual does not, and should not confer automatic access to information stored about that individual.

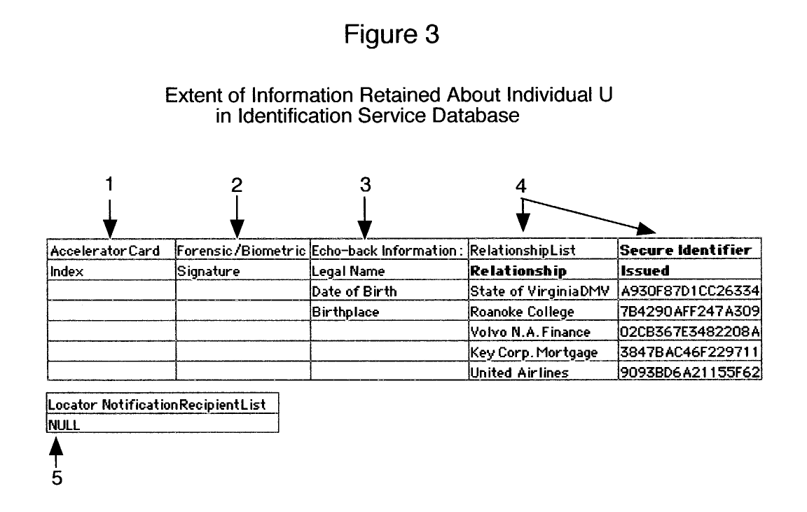

Accordingly, the information collected and maintained in the centralized identification service IS is limited to just that needed to render ID identification, privacy, and bad faith traceability. FIG. 3 shows the grouping of information retained for person U:

1) Accelerator Card index. For purposes of speeding up the forensic/biometric match process, the Identification Service IS may, in a preferred embodiment, issue a plastic card at the time of enrollment, which provides as a “fastlane” capability to its recipient. The information stored magnetically (or otherwise) on the card is limited to an arbitrary index number, different for each enrollee, and re-assignable at the wishes of the enrollee. At the point-of-identification, the card is scanned for the accelerator index number, and the index merged into the ID query as defined above. The identification service IS maintains a fast lookup data structure which quickly steers the search to the record corresponding to the recipient of the accelerator card. The accelerator card, if lost or stolen, is worthless to anyone but the person it was issued to. Sniffing the contents of the card will not yield any private information about its owner. Information brokers will not seize on this index number as a universal identifier because the card holder has the option of having a new number reassigned. An inexpensive magstripe card will suffice as an accelerator card.

2) Forensic/Biometric signature. A block of data containing the individual-unique data of forensic/biometric origin establishing personal identity going back to the time of enrollment, in the preferred embodiment, at birth. The detailed specification of which forensic/biometric data is collected, and how incoming data are matched to stored data, is not the subject of this invention. On the contrary, this aspect of the ID system is treated as a black box. Examples of technology which have demonstrated ability to handle tens of millions of enrollees are the Integrated Automated Fingerprint Identification System (IAFIS) and CODIS (DNA identification) systems developed and operated by the U.S. Federal Bureau of Investigation.

3) Echo-back information. To assure that the correct identity is matched in response to an ID query, the response packet contains echo-back information which may be viewed as text at the point-of-identification. The fields included are limited to legal name, DOB, and birthplace associated with the person identified. If the matchup based on the echo-back is rejected by the parties at the point-of-identification, the transaction is cancelled.

4) Relationship List w/Secure Identifiers Issued. As described in FIG. 6, when person U establishes a new relationship warranting secure identification of himself, resulting in issuance of a secure identifier to the requestor, a record of the identifier and to whom it was issued must be kept in the identification service database. The relationship list for person U is kept here. The identifiers used for the previous recipients of his secure identifiers are not the names shown (for illustrative purposes) but rather internal, private indexes which point to the records for these parties, whether they are individuals or organizations. These internal identifiers are safeguarded from becoming visible, so that they may not be seized upon as universal identifiers.

5) Locator Notification Recipient List (for bad faith traceability). With authorization from a magistrate shown probable cause, bad faith actors may be tracked down by flagging any incoming ID query which bears their forensic/biometric signature. The NULL list in the figure indicates that no such flag is in effect for person U. Entries in this list will distribute tracking event reports to recipients legally empowered to receive them.

Accretion of Population-Wide ID Database, Lifelong ID

Under the ID infrastructure design claimed herein as the preferred embodiment, secure identification is provided as a common service, offered throughout society, by a single, centralized provider. Moreover, a preferred method is to enroll individuals into this centralized ID system at birth, the disadvantage to later enrollment being an invitation to present falsified (i.e., non-secure) birth records at the time of enrollment. For the newborn infant, the usual incentives for identity crime (the covering over or changing of past history) simply do not exist, making this singular event the optimal time for establishing secure identity of persons.

Individual ID: Immutable Forensic Baseline+Surrogate Biometric Signature

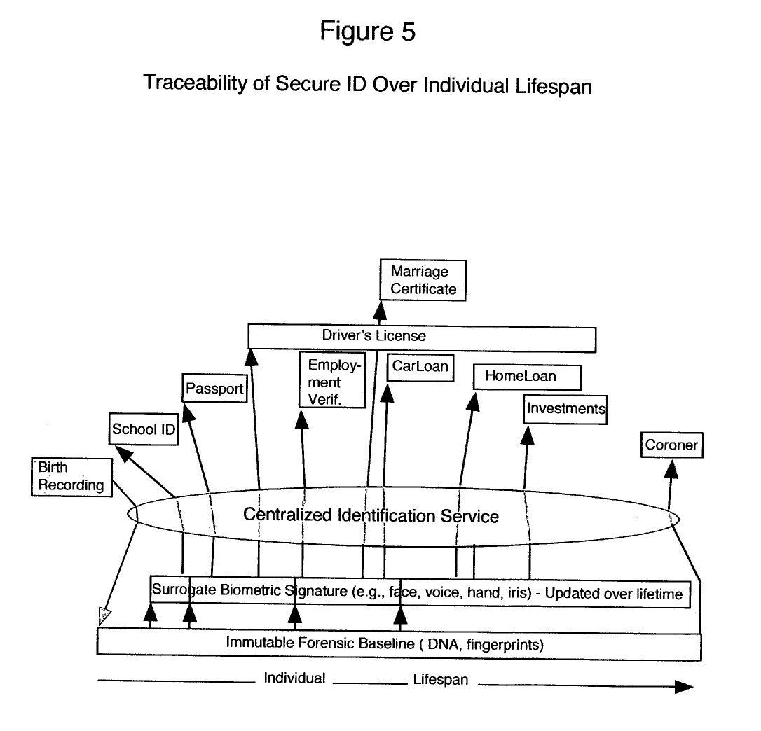

All individuals being enrolled into the ID system have identity established by collecting, processing and recording a forensic baseline, a set of biological/biometric data which by nature is unchangeable over the lifetime of the individual, and which on its own confers uniqueness among the entire global population. As shown in FIG. 5, the forensic baseline is the anchor that may be used at several junctures over a lifetime to establish (or update) a surrogate biometric signature (e.g., combining face, voice, hand, iris), which also meets the uniqueness criteria in order to support rapid authentication queries. The forensic baseline establishes the traceability of the surrogate biometric signature, which must be updated several times to keep pace with maturational changes (FIG. 5). Fraud is precluded during biometric signature updating by requiring an accompanying forensic sample (DNA cheek swab). The forensic baseline is also valuable to law enforcement for identifying suspects from crime scene evidence, and to coroners for positive ID of deceased. Legal name, DOB, and birthplace, are examples of echo-back information to be captured in the baseline as part of birth recording. These human-readable fields are echoed back during authentication queries to give confidence that the correct ID has been retrieved.

The specification details of which forensic/biometric signals are collected and processed in order to process ID queries is not the subject matter of this invention. Examples of the technology relied upon as extent can be found in the FBI's IAFIS (fingerprint) and CODIS (DNA) identification systems. Rather than teaching a detailed means of accomplishing identification matching, the invention put forth herein is a higher level infrastructure design which addresses society-wide ID/privacy architecture, one that embeds existing proven technologies such as IAFIS and CODIS as unspecified black box components.

IDs for Organizations, Authenticated Agency

As an extension of individual secure ID, organizations are invited to operate on the same level as individuals by establishing an official ID, such that all transactional behavior on behalf of the organization is personally-authenticated (authenticated agency). This provides a symmetric accountability relationship between individuals and organizations. This concept places a check on the ability to mount fraud under cloak of an untraceable organization, or through unauthorized agency (role impostering).

The same model of dyadic relationship establishment fits the pattern of an organization dealing with either individuals or other organizations. The key difference from person to person transactions is that additional means is provided for organizations to officially delegate agency to individuals, i.e., empowerment to establish relationships on behalf of the organization. When acting as an agent of an organization, at least one personal identity (the responsible individual) is offered to the opposite party for purposes of bad faith traceability. All persons assigned roles (responsible individual, or agent) must be already enrolled as known individuals in the ID system.

As a check on unauthorized agency (frauds where someone deceptively does business for an organization lacking proper authorization), the opposite party may insist on authentication of agency during relationship establishment. A forensic/biometric live scan of the agent must match up to a person in the database who is listed as a delegated agent of the organization.

To address the need for administering delegation of agency within large organizations, the responsible individual may authorize individuals as delegators, i.e., those who are empowered to add or delete authorized agents. All delegators must have established individual IDs.

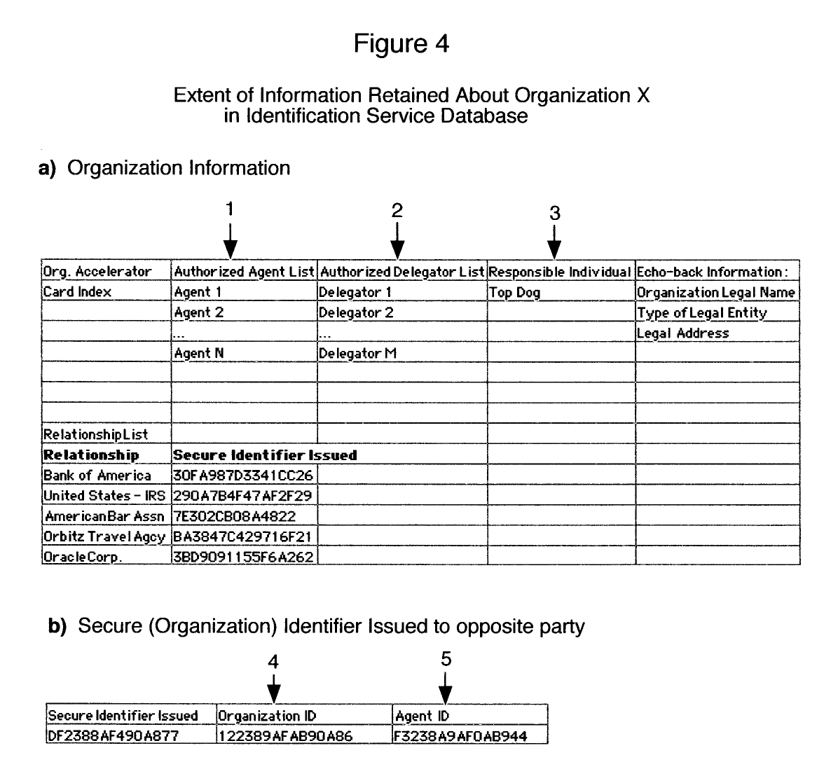

FIG. 4 illustrates the extent of information needing to be retained defining an Organization ID in the identification service IS. A record analogous to the record kept for an individual ID is shown in FIG. 4a. The record contains an Accelerator Card index and echo-back information previously described. There is no Locator Notification Recipient List, as all traceability of organizational misdeeds is levied through specific individuals who work for the organization.

Features specific to the information stored about an organization in FIG. 4a are:

1) Authorized Agent List. A list of the persons authorized to establish relationships and conduct transactions on behalf of the organization. The identifiers used in this list consist of internal, private indices which point to the records for these individuals. These internal identifiers are safeguarded from becoming visible, so that they may not be seized upon as universal identifiers.

2) Authorized Delegator List. A list of persons authorized to appoint (or remove) agents.

3) Responsible Individual. A single individual who takes ultimate responsibility for good faith performance of the organization. The sole person empowered to authorize delegators.

When the opposing party is dealing with an organization, and insists on secure identification of his counterpart, the secure identifier issued to him links back to the Organization ID and the personal ID of the agent who represented the organization, as shown in FIG. 4b. The two fields backtraceable through the secure ID given out are:

4) Organization ID. An internal, private index which points to the record of the Organization (containing a pointer to its responsible individual).

5) Agent ID. An internal, private index which points to the record of the agent who acted for the organization

There is no provision for an organization to authorize agency to another organization, as this obfuscates personal responsibility for organizational behavior, and opens the door to defeating accountability with shell organizations. Organizations that work together in partnership to establish outside relationships must do so with full clarity about which of them is undertaking the relationship, backtraceable to a specific responsible individual.

Secure Identifiers

A primary goal of Secure ID is to protect an individual's privacy of conduct and stored data against unauthorized sharing. This is accomplished through the use of relationship-specific identifiers. Under this principle, the individual is known by a different identifier in each organization he deals with, so that stored information cannot be linked across organizations without his permission.

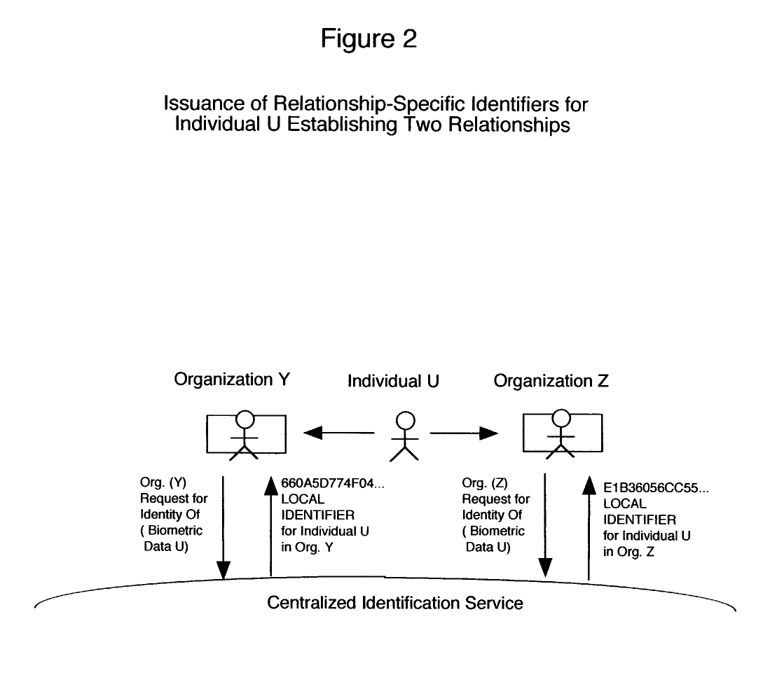

FIG. 2 illustrates how privacy is conferred from an individual's viewpoint in dealing with multiple organizations. Consider two different relationships established by individual U. In the first relationship, U is applying for a drivers license from a state DMV. We abstractly label the DMV as Organization Y. Org. Y scans a biometric signature from applicant U, and sends off a query requesting the identity of the applicant. What comes back is a local identifier, a unique number assigned to Org. Y for keeping track of person U. When this person reappears at the DMV, a repeat scan and query results in the same identifier being returned. This recognition function enables the DMV to recognize U, and precludes U from obtaining a 2^{nd} drivers license under an alias.

In the second relationship, individual U wants to apply for a mortgage loan from Org. Z. Org. Z scans a biometric signature, and sends off a query requesting the identity of the applicant. The ID service issues the lender its own local identifier to keep track of person U, different from the identifier issued to the DMV. These local identifiers serve the need of each organization to know whom they are dealing with across time, but prevent the unauthorized sharing of data about individual U across databases (data mining). Because the issuance of local identifiers bestows this powerful, privacy feature over stored personal data, the identifiers issued under this architecture are referred to as secure identifiers. Their use is intended to restore the traditional prerogative of persons to maintain privacy of conduct in relationships.

### Advantages of the Invention

The advantages of the invention are several:

By integrating secure identification services with the issuance of secure identifiers, a problem that has gone unsolved for 40 years, namely, erosion of privacy due to dependence on universal identifiers (e.g., SSN) may be finally redressed.

By proactively countering the potential of strong ID technology to make easier the tracking of personal behavior, and the assemblage and sale of detailed personal dossiers through data mining techniques (based on automated correlation across databases using universal identifiers such as SSN), the present invention increases the willingness of the public to accept strong (i.e. fraud-resistant) ID technology such as forensic/biometric matchup.

Secure identifier technology, the principle that the individual be known by a different identifier in each relationship established, is easy for the lay public to comprehend as a privacy mechanism, compared to techniques involving mathematical algorithms (such as PKI). Comprehensibility is an important advantage in gaining public acceptance of privacy architecture.

The present invention directly answers the key security vulnerability posited by decentralized adoption of forensic/biometric identification technology, namely, the uncontrolled proliferation of privately-owned ID databases containing forensic/biometric signatures of individuals, and with it, increased exposure to criminals intent on obtaining these signatures for illicit use. By centralizing identification services, and sequestering a forensic/biometric ID population database behind a single ultra-secure institutional boundary, the present invention provides a more effective security strategy for safeguarding invaluable forensic/biometric data assets.

The method of enrolling persons at birth posits advantages over later enrollment. Infants have no previous identity or history to escape. Forensic hand and footprints are routinely collected already. Establishment of nationality is determined starting at birth. Deferment of enrollment relegates identification of children to the honor system, and invites falsification of birth information. From an administrative standpoint, deferment of ID enrollment beyond birth has no practical benefits, and unnecessarily opens up avenues to fraud. International travel rules for children are difficult to enforce absent a system of secure ID starting from birth.

In contrast to a plethora of authentication systems whose scope is limited to on-line users of computer systems (and imposing ID stability only from log-on session to session), the present invention addresses the need for birth to death ID stability of individuals in the general population across the gamut of relationships they establish. The infrastructure claimed herein would provide a more secure foundation for on-line identification due to its ability to forge a traceable ID link reaching outside the realm of an individual's computer use. A distinct advantage is that it denies the computer user assumption of multiple alias identities when signing up for on-line services. (However, these advantages only pertain to sign-ups where the applicant is physically present for live biometric scanning—remote authentication admits avenues for data manipulation.)

Centralization of ID services as disclosed herein derives advantage from an economy of scale. Once identification of people is functionally decoupled from retrieval of information about them, the needs for identification become homogeneous and ubiquitous throughout society. Comparatively, having each organization that needs secure ID services develop their own independent biometric add-on to existing systems is a wasteful duplication of effort.

By extending secure ID concepts to organizations, providing for organizational ID, supporting authenticated agency on behalf of organizations, and bad faith traceability for organizational agents, the present invention is advantageous for confronting “disappearing organization” scams, sophisticated role frauds involving unauthorized agency, and obfuscation of responsibility behind shell companies.

Centralization of secure identification services provides new capabilities for homeland security and law enforcement. The ability to pinpoint the origin of ID queries can provide a locator capability for wanted persons. The ability of fugitives to live “underground” for long stretches would become curtailed as more relationships come to require secure identification. A full population forensic ID database would be useful in the field of crime scene investigation, and for rapid ID of unknown deceased.

An integrated, balanced approach to the needs for fraud-resistant ID, citizen privacy, bad faith traceability, trustable commerce, and effective law enforcement, gives the current invention an advantage over less comprehensive designs.

What is claimed is:

1. A method for providing secure personal identification and privacy infrastructure toward curtailment of identity crimes and enhanced privacy, comprising:
a. a centralized identification service housing a forensic/biometric population database, and
b. the receipt and processing of identification queries by said identification service, where the query originates from a self-identifying requesting party who is requesting the identity of a unknown person who is physically present with the requesting party, and
c. the identification service makes a positive authentication of the requesting party through means of forensic/biometric matchup to a person (or organizational agent) already represented in the forensic/biometric population database, or through other reliable means traceable back to a forensic/biometric matchup, and
d. contingent upon positive matchup of live scan forensic/biometric data collected from the person whose identity is being requested to a person already represented in the forensic/biometric population database, the issuing of a relationship-specific identifier back to the requestor for his local use in storing and accessing data records pertaining to this individual over an indefinite relationship duration, and
e. contingent upon the matchup described in d), also sending back to the requestor a decision as to whether his request for the identity of this individual represents his first encounter with this individual or a repeat encounter, and
f. storage by the identification service of all relationship-specific identifiers issued historically into a highly secure and persistent database whereby they may be rapidly accessed to support the decision described in e), and
g. in response to every query originating from the same ordered pairing of requestor (or requestor organization if requested by a delegate) and person whose identity is being requested, the identification service returns the same relationship-specific identifier, and
h. the issuance of a relationship-specific identifier (as opposed to a universal identifier) in response to an identification query, permitting an individual to be known by a different identifier in the many relationships he cares to establish, and denying the ability to correlate by automated means via a universal identifier the personal information shared privately within these relationships, and
i. in the event of bad faith performance of an individual in a relationship, the back tracing of identity from a relationship-specific identifier to a single persona represented in the forensic/biometric population database, toward levying of consequences and remedies, and
j. with proper legal due process, the centralized identification service handling an authenticated request from law enforcement to assist in locating a wanted person by tipping off the authorities to the origin of an incoming identification request bearing the forensic/biometric signature of the wanted person.

2. The method in accordance with claim 1d wherein the relationship-specific identifier returned to the requestor is a binary number drawn from a number space suitably large to manage relationships among a global population size.

3. The method in accordance with claim 1 wherein an organization may establish a secure identity by delegating agency to officers or others whose identities as individuals are already authenticatable under the system, empowering them as agents to establish relationships on behalf of the organization.

4. The method in accordance with claim 1 wherein confirmatory echo-back information, such as legal name, date of birth, and birthplace are additionally sent to the requestor in response to an identification query, in order to verify that the correct identification has been made.
